(19) United States
(12) Patent Application Publication
(10) Pub. No.: US 2012/0136739 A1
(43) Pub. Date: May 31, 2012

(54) MOBILE PAYMENT METHOD AND SYSTEM USING BARCODE

(75) Inventor: Seung-Kyu CHUNG, Anyang-si (KR)

(73) Assignee: KCP CO., LTD, Seoul (KR)

(21) Appl. No.: 13/018,692

(22) Filed: Feb. 1, 2011

(30) Foreign Application Priority Data
Nov. 30, 2010 (KR) 10-2010-0120968

(51) Int. Cl. G06Q 30/00; G06F 17/00; G06Q 20/00

(52) U.S. Cl. 705/26.1; 235/375

(57) ABSTRACT

A mobile payment method using a barcode is provided. In the method, a barcode is scanned using a mobile terminal of a member store to extract product information and/or payment-related information written to the barcode. Information of a payment methods selected by a customer is input to the mobile terminal and the input information is combined with the extracted product information and payment-related information to generate payment information. The payment information is transmitted to a payment server through or without passing through a relay server. The mobile terminal receives a payment confirmation code from the relay server or the payment server.

### BACKGROUND OF THE INVENTION

1. Field of the Invention

The present invention relates to a mobile payment method and system using a barcode, and more particularly to a mobile payment method and system using a barcode, wherein it is possible to easily and safely make payment by scanning a barcode attached to a product or a package thereof using a mobile terminal.

2. Description of the Related Art

A mobile communication terminal, which has become a necessity of modern life, has been significantly reduced in size and weight through continued development. A multifunctional communication terminal having a variety of functions such as an MP3 player function, a camera function, and a navigation system function has also become available. The mobile communication terminal also provides a variety of functions and services, for example, a voice mail service (for example, a so-called Sorisam service provided in Korea) that allows the caller to leave a message in a voice mail box or fax box of the recipient when the recipient cannot receive calls, a voice activated dialing service that allows the user to dial a phone number by speaking the number, which they have memorized/registered through a voice recognition device connected to the mobile communication terminal, without having to press keys to enter the phone number, a Short Message Service (SMS) which allows the user to receive text messages (40 to 50 Korean letters or about 80 English letters) or various life information through a screen of the mobile communication terminal and which notifies the user of the receipt of a message arriving at the voice mail box and which also supports a mobile phone paging service.

In the meantime, a barcode attached to a product is used to read information regarding the product. Specifically, barcodes are read through a barcode scanner mounted on a cash register or a Point Of Sale (POS) system in a big store. In this manner, barcodes are very useful for automated collection of sales data. The range of use of barcodes has been steadily increased as the barcode structure has been extended from a one-dimensional linear arrangement to a two-dimensional or higher arrangement to significantly increase the amount of information that can be contained in the barcode. However, the cash register or POS system is not only expensive but also has a security problem in that it is vulnerable to card cloning through hardware manipulation.

Under these circumstances, a payment method using a mobile terminal, which has the advantage of high security, has recently entered into widespread use. Although the payment method using a mobile terminal has an advantage in that the user can immediately pay for a product using the mobile terminal on the spot since they always carry the mobile terminal, it is not easy to acquire detailed information regarding the product and a member store that sells the product.

Accordingly, there is a need to provide a novel payment method which eliminates the need for a member store to be equipped with an expensive payment system, prevents customers from buying undesired products on impulse or by mistake based on incorrect information, and allows customers to make the right decision when purchasing products.

### SUMMARY OF THE INVENTION

Therefore, the present invention has been made in view of the above problems, and it is an object of the present invention to provide a mobile payment method and system using a barcode, wherein it is possible to perform a payment service through an inexpensive and simple procedure without the need for a store owner or clerk of a member store to be equipped with an expensive credit card terminal, receipt paper, and the like.

It is another object of the present invention to provide a mobile payment method and system using a barcode, wherein a customer can immediately check information regarding a product, which they desire to purchase, by scanning a barcode displayed on the product using a mobile terminal and can also immediately perform a payment process using the mobile terminal on the spot.

In accordance with an aspect of the present invention, the above and other objects can be accomplished by the provision of a mobile payment method using a barcode, the method including scanning a barcode using a mobile terminal of a member store to extract product information and/or payment-related information written to the barcode, inputting information of a payment methods selected by a customer to the mobile terminal and combining the input information with the extracted product information and payment-related information to generate payment information, transmitting the payment information to a payment server through or without passing through a relay server, and receiving, by the mobile terminal, a payment confirmation code from the relay server or the payment server.

In accordance with another aspect of the present invention, there is provided a mobile payment method using a barcode, the method including scanning a barcode using a mobile terminal of a customer to extract product information and/or payment-related information written to the barcode, inputting information of a payment methods selected by a customer to the mobile terminal and combining the input information with the extracted product information and payment-related information to generate payment information, transmitting the payment information to a payment server through or without passing through a relay server, and receiving, by the mobile terminal, a payment confirmation code from the relay server or the payment server.

In accordance with yet another aspect of the present invention, there is provided a mobile payment method using a barcode, the method including receiving, by a member store server, a product code and/or payment-related information extracted from a barcode scanned using a mobile terminal held by a customer, transmitting detailed product information and payment-related information corresponding to the received barcode data from the member store server to the mobile terminal, and receiving, by the member store server, a payment confirmation code, which a payment server generates in response to a payment request from the mobile terminal, from the payment server or from a relay server.

In accordance with another aspect of the present invention, there is provided a mobile payment method using a barcode, the method including receiving, by a relay server, product information and payment-related information acquired by scanning a barcode of a specific product using a mobile terminal held by a customer, a store owner, or a clerk and payment information including payment methods information corresponding to a payment methods selected by the customer from the mobile terminal, transmitting the payment information from the relay server to a payment server to request payment verification and approval, and receiving, by the relay server, a payment confirmation code from the payment server and transmitting the payment confirmation code from the relay server to a member store server and the mobile terminal.

In the mobile payment method, the mobile terminal may be a smart phone, a PDA, or a tablet PC having a scanner function.

In the mobile payment method, the barcode may be a one-dimensional barcode, a two-dimensional barcode, or a three-dimensional barcode.

### BRIEF DESCRIPTION OF THE DRAWINGS

The above and other objects, features and other advantages of the present invention will be more clearly understood from the following detailed description taken in conjunction with the accompanying drawings, in which:

FIG. 1 illustrates an overall configuration of a mobile payment system using a barcode according to a first embodiment of the present invention;

FIG. 2 illustrates an exemplary mobile payment process using a barcode according to the first embodiment of the present invention;

FIG. 3 illustrates an overall configuration of a mobile payment system using a barcode according to a second embodiment of the present invention;

FIG. 4 illustrates an exemplary mobile payment process using a barcode according to the second embodiment of the present invention;

FIG. 5 illustrates an overall configuration of a mobile payment system using a barcode according to a third embodiment of the present invention;

FIG. 6 illustrates an exemplary mobile payment process using a barcode according to the third embodiment of the present invention;

FIG. 7 illustrates an overall configuration of a mobile payment system using a barcode according to a fourth embodiment of the present invention; and

FIG. 8 illustrates an exemplary mobile payment process using a barcode according to the fourth embodiment of the present invention.

### DETAILED DESCRIPTION OF THE INVENTION

The present invention provides a mobile payment method using a barcode, the method including scanning a barcode using a mobile terminal of a member store to extract product information and/or payment-related information written to the barcode, inputting information of a payment methods selected by a customer to the mobile terminal and combining the input information with the extracted product information and payment-related information to generate payment information, transmitting the payment information to a payment server through or without passing through a relay server, and receiving, by the mobile terminal, a payment confirmation code from the relay server or the payment server. In addition, the present invention provides a mobile payment method using a barcode, the method including scanning a barcode using a mobile terminal of a customer to extract product information and/or payment-related information written to the barcode, inputting information of a payment methods selected by a customer to the mobile terminal and combining the input information with the extracted product information and payment-related information to generate payment information, transmitting the payment information to a payment server through or without passing through a relay server, and receiving, by the mobile terminal, a payment confirmation code from the relay server or the payment server. The barcode includes a barcode selected from a one-dimensional barcode, a two-dimensional barcode, and a three-dimensional barcode displayed on a product or an advertisement medium.

The one-dimensional (1D) barcode is a horizontal linear code representing a number or a simple character(s) through a combination and arrangement of bars (or black bars) and spaces (or white bars). The 1D barcode includes bars arranged only in a horizontal direction (X-direction) and does not contain any information in a vertical direction (Y-direction) and thus has a limited information storage capacity.

The two-dimensional (2D) barcode is a dot-shaped or matrix code that includes planer information arranged in both horizontal and vertical directions. The 2D barcode can overcome problems associated with limited information capacity of the 1D barcode. The 2D barcode can encode about 100 times as much information as the 1D barcode in the same area in the form of a 2D symbol within a small square. Thus, the 2D barcode can contain various types of information including not only text such as letters and numbers but also graphics, photos, voice, fingerprints, and signatures. Currently, about 20 types of 2D barcodes have been developed and used. It is recommended that 4 international standard 2D barcodes, PDF417, DataMatrix, MaxCod, and QR Code, be used among the 20 2D barcodes.

One example of the three-dimensional (3D) barcode is a color combination tag. For example, a color code developed by Microsoft cannot be read by a conventional 2D code reader but can be read by an application “Tag Reader” distributed by Microsoft. Many new models of mobile terminals or the like, which support a large number of file formats in addition to QR code and also support barcode readers, have been introduced recently.

In the present invention, the barcode includes product information and payment-related information.

The product information includes at least one of a product name, a product code, and a product price and preferably includes all of them. For example, the product information may include only the product code as needed. Callback URL information required to access a member store server may be incorporated into the barcode so that the customer can directly access the member store server through the barcode to check product information. In this case, it is possible to expose the user to other products registered in the member store, thereby achieving advertisement effects.

The payment-related information includes at least one of a member store number, a member store ID, and a URL of a relay server or a payment server and preferably includes all of them. Through the member store number or the member store ID included in the payment-related information, the relay server or the payment server can determine whether or not the member store associated with payment for the product has been registered in their database. Through the URL information included in the payment-related information, the mobile terminal can access the relay server or the payment server.

In the present invention, the payment information includes information required for payment among the information items included in the product information and the payment-related information. This information required for payment may vary depending on the type of payment institution involved. For example, the payment information may not include information such as the product name which is not essential for payment, depending on the payment institution involved. The payment information also includes, as payment methods information, information of selection of a payment methods such as a credit card, a mobile phone, or wire transfer, a card number (together with an expiration date as needed), and a unique ID number such as a social security number.

The present invention will now be described in more detail with reference to the drawings which illustrate various embodiments of the present invention.

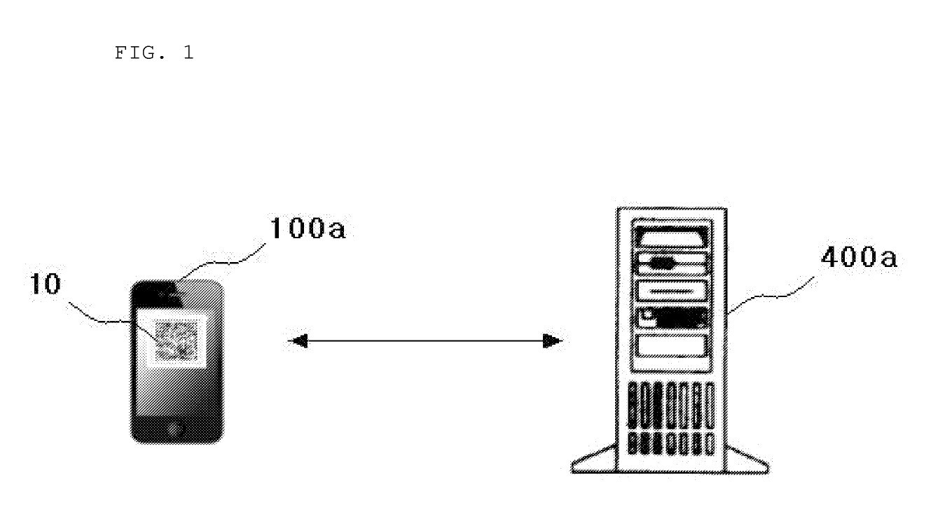

FIG. 1 illustrates a configuration of a mobile payment system that performs mobile payment using a barcode according to a first embodiment of the present invention.

The mobile payment system according to the present invention includes a mobile terminal 100a and a payment server 400a.

The mobile terminal 100a in the first embodiment is a terminal that is held by a store owner or a clerk and that supports product payment at a member store. The mobile terminal 100a can perform product payment through wireless Internet and includes a device (for example, a camera or scanner) that can scan a barcode. A program for extracting data from the scanned barcode is installed in the mobile terminal 100a. Examples of the mobile terminal include a smart phone, a PDA, and a tablet PC such as an iPad (model name) or a Galaxy Tab (model name) in which a known scanner application has been installed.

The payment server 400a is a server that is operated by a payment institution such as a financial institution, a credit card company, or a mobile communication company that performs verification and payment approval processes associated with general mobile payment. The payment server 400a performs verification and approval processes associated with mobile payment in conjunction with the mobile terminal 100a.

When the mobile terminal 100a has selected online payment through wireless banking, a funds transfer system of a bank, a financial management network, and the like serve as a payment server. When the mobile terminal 100a has selected payment through a credit card, a card approval system of a credit card company, a Value Added Network (VAN), and the like serve as a payment server. When the mobile terminal 100a has selected micropayment through a mobile communication payment claim, a communication fee payment system of a mobile communication company or the like serves as a payment server.

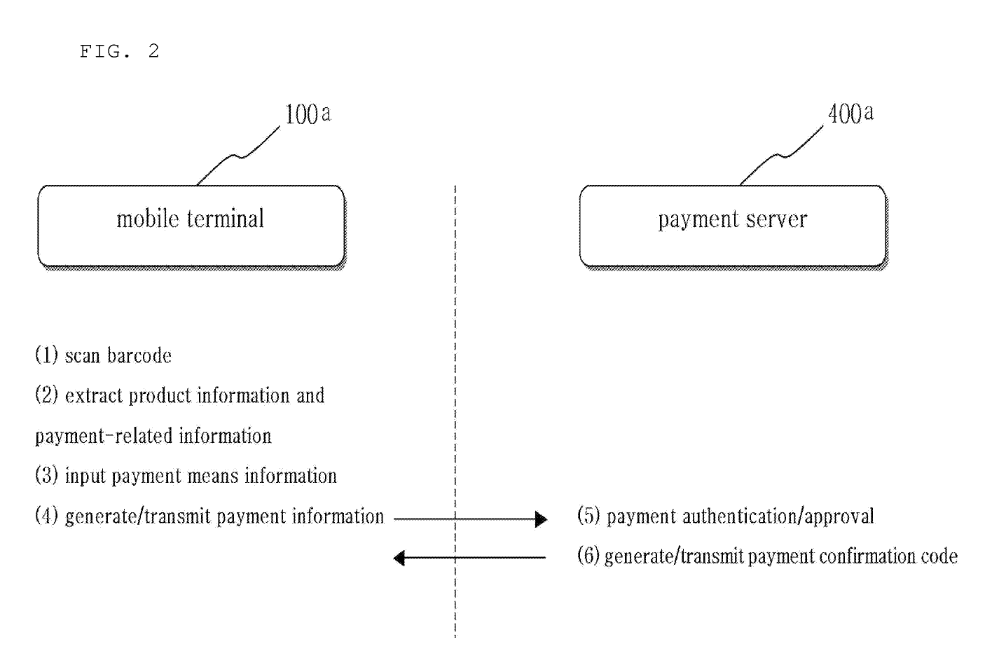

A mobile payment process using a barcode according to the first embodiment of the present invention is described below with reference to FIG. 2.

When a store owner or a clerk scans a barcode displayed on a product selected by a customer or displayed on a packing paper of the product using a mobile terminal 100a held by the store owner or clerk, the mobile terminal 100a extracts product information and member store information from the scanned barcode.

Here, a member store server (not shown) may be provided such that it is possible to check detailed product information and payment-related information through the member store server as needed. In this case, the mobile terminal 100a may request and receive detailed product information and payment-related information from the member store server. The member store server includes not only a server that is directly operated by the member store but also a server that is operated by a third party and that provides product information to the member store. In this case, essential product information (for example, a product code) may be written to the barcode and detailed product information (including updated information) may be registered in the member store server to allow the mobile terminal 100a to request such detailed product information from the member store server.

Thereafter, a page (or window) which enables selection of a payment methods is displayed on a screen of the mobile terminal 100a. This page may be generated by the mobile terminal 100a. A page, which enables selection of a payment methods currently available in the member store, may also be provided by the member store server (not shown). In this case, the mobile terminal 100a may access the member store server (not shown) to receive the page from the member store server.

Generally, payment methods such as cash payment (for example, bank transfer or mobile phone micropayment), wire transfer, and credit card are displayed on the page (or window), which enables payment methods selection, of the mobile terminal 100a to allow the customer to select a desired payment methods.

When the customer has selected a specific payment methods through the mobile terminal 100a, the mobile terminal 100a is connected to a payment server 400a corresponding to the payment methods and the payment server 400a transmits a page, which enables input of payment methods information, to the mobile terminal 100a.

The payment methods information includes an account number, a PIN number, an account holder, a social security number, and the like in the case of wire transfer, includes a card number, an expiration date, a PIN number, and the like in the case of credit card payment, and includes a mobile phone number, a social security number, and the like in the case of mobile phone micropayment.

The mobile terminal 100a transmits the payment information to the payment server 400a to request payment for the product.

Upon receiving the payment information from the mobile terminal 100a, the payment server 400a reads information regarding the member store and customer and performs payment verification and approval processes for the product. Subsequently, the payment server 400a may perform the same payment verification and approval processes as in the conventional electronic payment procedure. That is, the payment server 400a determines whether or not the member store has been registered in a server of the same company based on the received payment information and then transmits a payment confirmation code for the requested payment to the mobile terminal 100a upon determining that payment is possible.

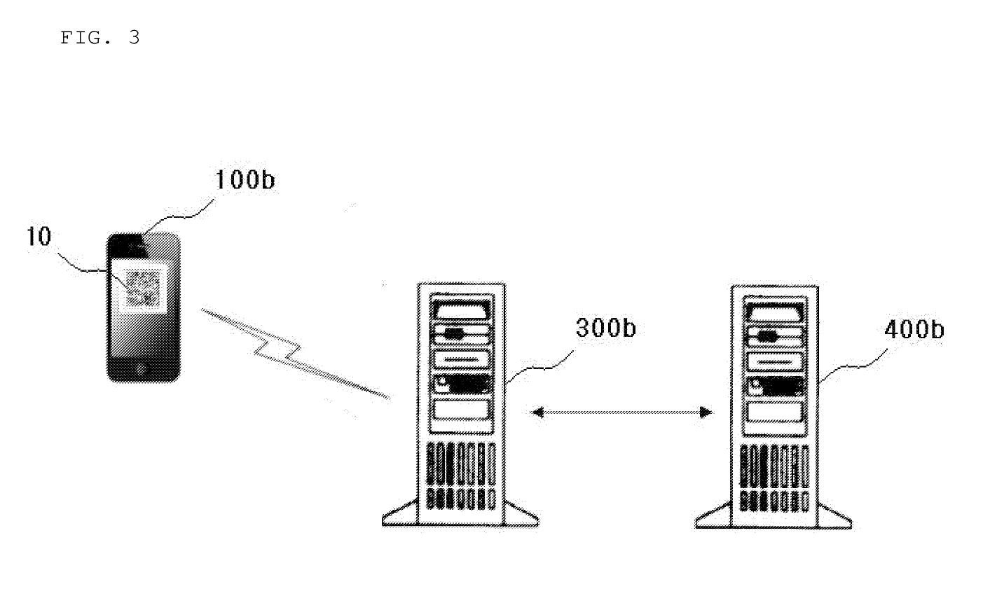

FIG. 3 illustrates a configuration of a mobile payment system that performs mobile payment using a barcode according to a second embodiment of the present invention.

The mobile payment system according to the present invention includes a mobile terminal 100b, a relay server 300b, and a payment server 400b.

The mobile terminal 100b is a terminal that is held by a store owner or a clerk of a member store. The mobile terminal 100b can perform product payment through wireless Internet and includes a device (for example, a camera or scanner) that can scan a barcode. A program for extracting data from the scanned barcode is installed in the mobile terminal 100b. Examples of the mobile terminal include a smart phone, a PDA, and a tablet PC such as an iPad (model name) or a Galaxy Tab (model name) in which a known scanner application has been installed.

The relay server 300b is operated by a Payment Gateway (PG) company that provides electronic payment services over the Internet. The relay server 300b is connected to the mobile terminal 100b and the payment server 400b through a network to perform processes associated with mobile payment. The relay server 300b also performs verification and approval processes for mobile payment in conjunction with the payment server 400b in response to a payment request from the mobile terminal 100b.

The payment server 400b is operated by a payment institution such as a financial institution, a credit card company, or a mobile communication company that performs verification and payment approval processes associated with general mobile payment. The payment server 400b performs verification and approval processes associated with mobile payment in conjunction with the relay server 300b.

When the mobile terminal 100b has selected online payment through wireless banking, a funds transfer system of a bank, a financial management network, and the like serve as a payment server. When the mobile terminal 100b has selected payment through a credit card, a card approval system of a credit card company, a Value Added Network (VAN), and the like serve as a payment server. When the mobile terminal 100b has selected micropayment through a mobile communication payment claim, a communication fee payment system of a mobile communication company or the like serves as a payment server.

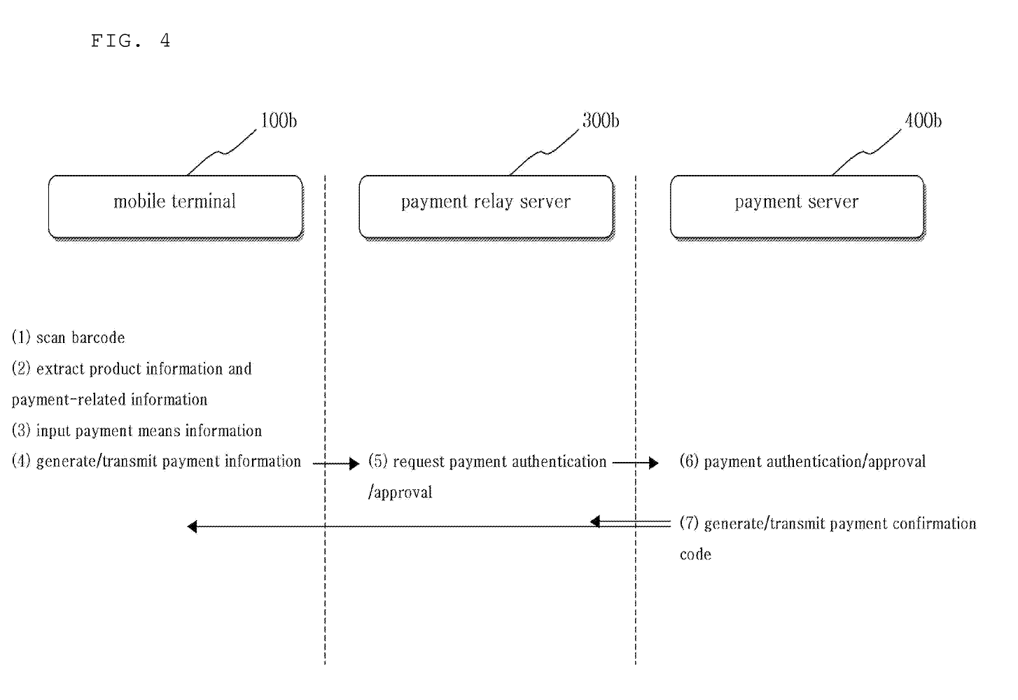

A mobile payment process using a barcode according to the second embodiment of the present invention is described below with reference to FIG. 4.

When a store owner or a clerk scans a barcode displayed on a product selected by a customer or displayed on a packing paper of the product using a mobile terminal 100b held by the store owner or clerk, the mobile terminal 100b extracts product information and member store information from the scanned barcode.

Here, a member store server (not shown) may be provided such that it is possible to check detailed product information and payment-related information through the member store server as needed. In this case, the mobile terminal 100b may request and receive detailed product information and payment-related information from the member store server. The member store server includes not only a server that is directly operated by the member store but also a server that is operated by a third party and that provides product information to the member store. In this case, essential product information (for example, a product code) may be written to the barcode and detailed product information (including updated information) may be registered in the member store server to allow the mobile terminal 100b to request such detailed product information from the member store server.

Thereafter, a page (or window) which enables selection of a payment methods is displayed on a screen of the mobile terminal 100b.

Generally, payment methods such as cash payment (for example, bank transfer or mobile phone micropayment), wire transfer, and credit card are displayed on the window, which enables payment methods selection, of the mobile terminal 100b to allow the customer to select a desired payment methods.

When the customer has selected a specific payment methods through the mobile terminal 100b, the mobile terminal 100b is connected to a relay server 300b corresponding to the payment methods and the relay server 300b transmits a page, which enables input of payment methods information, to the mobile terminal 100b.

Generally, payment methods such as cash payment (for example, bank transfer or mobile phone micropayment), wire transfer, and credit card are displayed on the window, which enables payment methods selection, of the mobile terminal 100b to allow the customer to select a desired payment methods.

When the customer has selected a specific payment methods through the mobile terminal 100b, the relay server 300b transmits a page, which enables input of payment methods information, to the mobile terminal 100b.

The payment methods information includes an account number, a PIN number, an account holder, a social security number, and the like in the case of wire transfer, includes a card number, an expiration date, a PIN number, and the like in the case of credit card payment, and includes a mobile phone number, a social security number, and the like in the case of mobile phone micropayment.

The mobile terminal 100b of the store owner or clerk of the member store transmits the payment information to the relay server 300b to request payment for the product.

Upon receiving the payment information from the mobile terminal 100b, the relay server 300b transmits the payment information to a payment server 400b specified by the customer to request payment verification and approval of the product.

The payment server 400b determines whether or not the member store has been registered in a server of the same company based on the received payment information and then transmits a payment confirmation code for the requested payment upon determining that payment is possible.

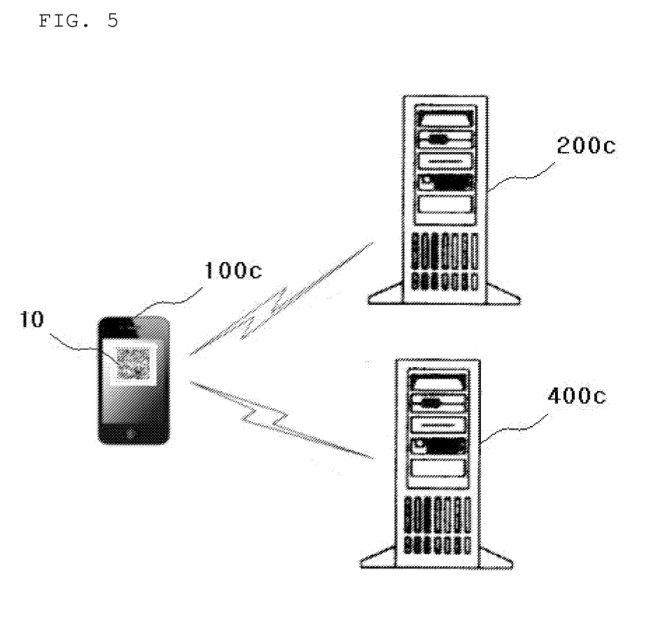

FIG. 5 illustrates a configuration of a mobile payment system that performs mobile payment using a barcode according to a third embodiment of the present invention.

The mobile payment system according to the present invention includes a mobile terminal 100c, a member store server 200c, and a payment server 400c.

The mobile terminal 100c is a terminal that is held by a customer. The mobile terminal 100c can perform product payment through wireless Internet and includes a device (for example, a camera or scanner) that can scan a barcode. A program for extracting data from the scanned barcode is installed in the mobile terminal 100c. Examples of the mobile terminal include a smart phone, a PDA, and a tablet PC such as an iPad (model name) or a Galaxy Tab (model name) in which a known scanner application has been installed.

The member store server 200c may be an Internet shopping mall server that provides goods or services. In the case where the customer purchases a product at a store offline, the member store server 200c may be a member store terminal possessed by the store. The member store server 200c stores and manages barcode data (i.e., product information and payment-related information) received from the mobile terminal 100c in a database and transmits such information to the mobile terminal 100c as needed.

The payment server 400c is operated by a payment institution such as a financial institution, a credit card company, or a mobile communication company that performs verification and payment approval processes associated with general mobile payment. The payment server 400c performs verification and approval processes associated with mobile payment in conjunction with the mobile terminal 100c.

When the mobile terminal 100c has selected online payment through wireless banking, a funds transfer system of a bank, a financial management network, and the like serve as a payment server. When the mobile terminal 100c has selected payment through a credit card, a card approval system of a credit card company, a Value Added Network (VAN), and the like serve as a payment server. When the mobile terminal 100c has selected micropayment through a mobile communication payment claim, a communication fee payment system of a mobile communication company or the like serves as a payment server.

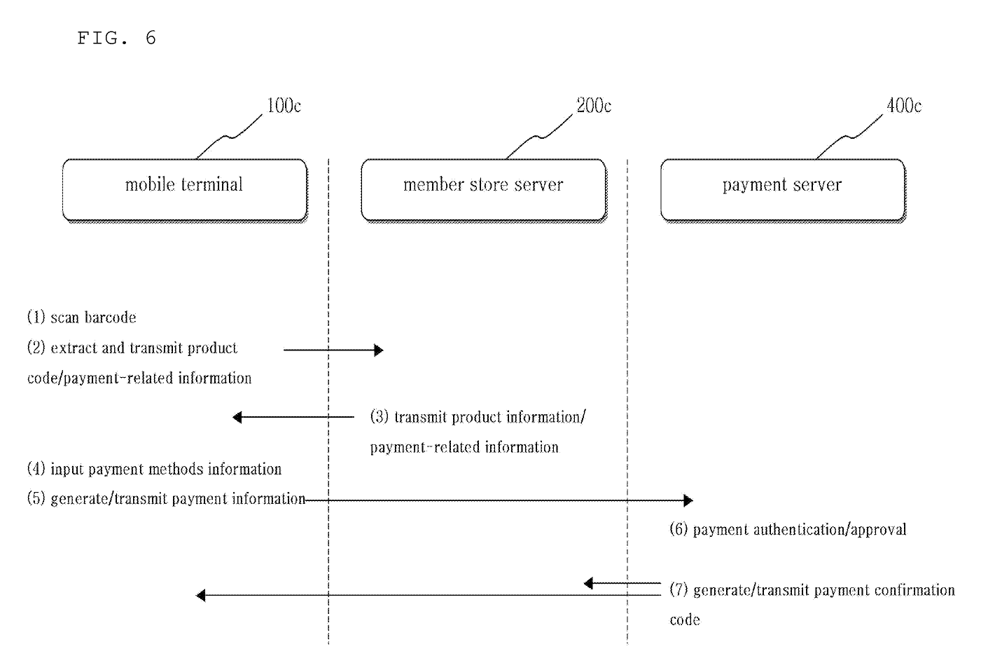

A mobile payment process using a barcode according to the third embodiment of the present invention is described below with reference to FIG. 6.

When a customer scans a barcode displayed on a product or a barcode displayed on a computer, a TV, a newspaper, a leaflet, a book, a packing paper, or the like, which displays the product, using a mobile terminal 100c held by the customer, the mobile terminal 100c extracts at least product code and/or payment-related information from the scanned barcode. Here, the member store server 200c may be constructed such that it is possible to check detailed product information and payment-related information through the member store server 200c as needed. In this case, the mobile terminal 100c may request and receive detailed product information and payment-related information from the member store server 200c. The member store server 200c includes not only a server that is directly operated by the member store but also a server that is operated by a third party and that provides product information to the member store.

Here, preferably, the barcode includes member store server information (for example, callback URL information) that provides detailed product information or the like and is programmed to allow the mobile terminal 100c to automatically access the member store server when data is extracted from the barcode. Thus, the customer may receive detailed information regarding the product and the member store from the member store server 200c simply by scanning the barcode through the mobile terminal 100c.

The member store server 200c receives the barcode data including the product information from the mobile terminal 100c and transmits detailed product information or the like corresponding to the received barcode data to the mobile terminal 100c. In this manner, the mobile terminal 100c may receive updated product information from the member store server 200c. Accordingly, in this case, essential product information (for example, a product code) may be written to the barcode and detailed product information (including updated information) may be registered in the member store server 200c to allow the mobile terminal 100c to request such detailed product information from the member store server 200c.

When the customer has made a request to purchase a product displayed on the screen of the mobile terminal 100c held by the customer, the member store server 200c transmits a page for payment methods selection to the mobile terminal 100c.

Generally, payment methods such as cash payment (for example, bank transfer or mobile phone micropayment), wire transfer, and credit card are displayed on the window, which enables payment methods selection, of the mobile terminal 100c to allow the customer to select a desired payment methods.

When the customer has selected a specific payment methods through the mobile terminal 100c, the mobile terminal 100c is connected to a payment server 400c corresponding to the payment methods and the payment server 400c transmits a page, which enables input of payment methods information, to the mobile terminal 100c.

The payment methods information includes an account number, a PIN number, an account holder, a social security number, and the like in the case of wire transfer, includes a card number, an expiration date, a PIN number, and the like in the case of credit card payment, and includes a mobile phone number, a social security number, and the like in the case of mobile phone micropayment.

The customer transmits the payment information to the payment server 400c through the mobile terminal 100c to request payment for the product.

Upon receiving the payment information from the mobile terminal 100c, the payment server 400c reads information regarding the member store and customer and performs payment verification and approval processes for the product. The payment server 400c determines whether or not the member store has been registered in a server of the same company based on the received payment information and then transmits a payment confirmation code for the requested product payment to the mobile terminal 100c and/or the member store server 200c upon determining that payment is possible.

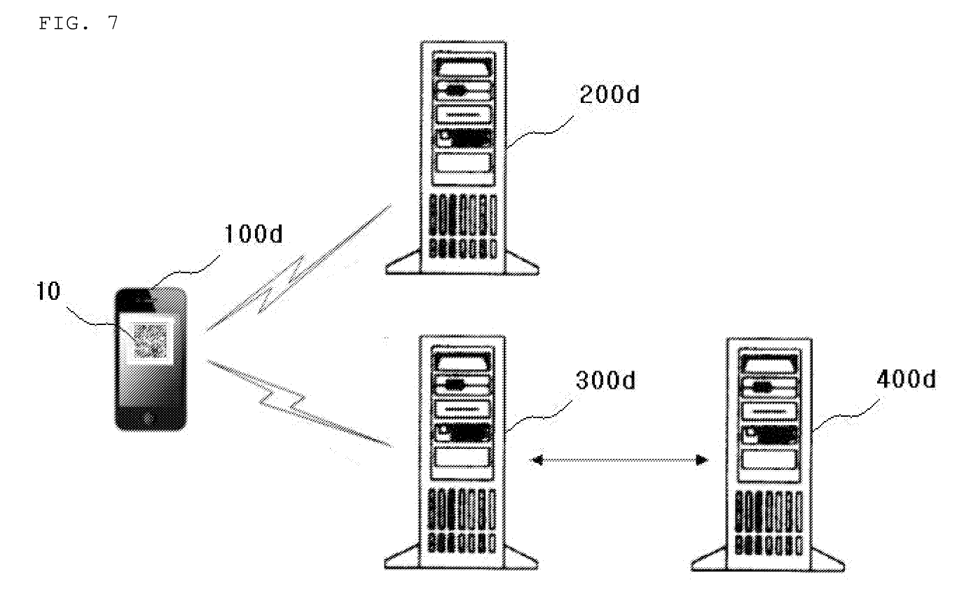

FIG. 7 illustrates a configuration of a mobile payment system that performs mobile payment using a barcode according to a fourth embodiment of the present invention.

The mobile payment system according to the present invention includes a mobile terminal 100d, a member store server 200d, a relay server 300d, and a payment server 400d.

The mobile terminal 100d is a terminal that is held by a customer. The mobile terminal 100d can perform product payment through wireless Internet and includes a device (for example, a camera or scanner) that can scan a barcode. A program for extracting data from the scanned barcode is installed in the mobile terminal 100d. Examples of the mobile terminal include a smart phone, a PDA, and a tablet PC such as an iPad (model name) or a Galaxy Tab (model name) in which a known scanner application has been installed.

The member store server 200d may be an Internet shopping mall server that provides goods or services. In the case where the customer purchases a product at a store offline, the member store server 200d may be a member store terminal possessed by the store. The member store server 200d stores and manages barcode data (i.e., product information and payment-related information) received from the mobile terminal 100d in a database and transmits such information to the mobile terminal 100d as needed.

The relay server 300d is operated by a Payment Gateway (PG) company that provides electronic payment services over the Internet. The relay server 300d is connected to the mobile terminal 100d and the payment server 400d through a wired/wireless network to perform processes associated with mobile payment. The relay server 300d performs verification and approval processes for mobile payment in conjunction with the payment server 400d in response to a payment request from the mobile terminal 100d.

The payment server 400d is operated by a payment institution such as a financial institution, a credit card company, or a mobile communication company that performs verification and payment approval processes associated with general mobile payment. The payment server 400d performs verification and approval processes associated with mobile payment in conjunction with the relay server 300d.

When the mobile terminal 100d has selected online payment through wireless banking, a funds transfer system of a bank, a financial management network, and the like serve as a payment server. When the mobile terminal 100d has selected payment through a credit card, a card approval system of a credit card company, a Value Added Network (VAN), and the like serve as a payment server. When the mobile terminal 100d has selected micropayment through a mobile communication payment claim, a communication fee payment system of a mobile communication company or the like serves as a payment server.

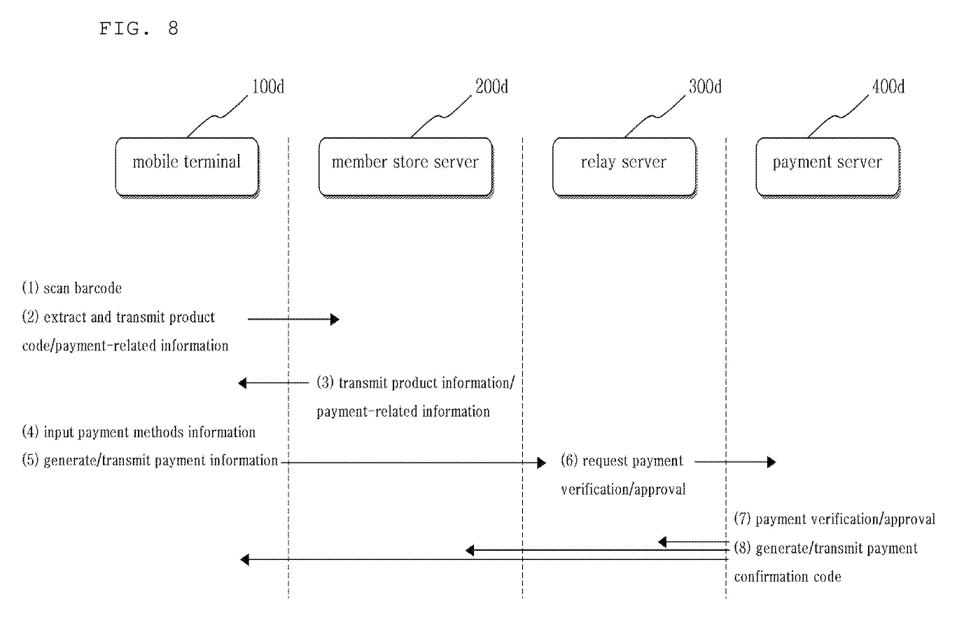

A mobile payment process using a barcode according to the fourth embodiment of the present invention is described below with reference to FIG. 8.

When a customer scans a barcode displayed on a computer, a TV, a newspaper, a leaflet, a book, a packing paper, or the like, which displays a product, using a mobile terminal 100d of the customer, the mobile terminal 100d extracts product information and payment-related information from the scanned barcode. Here, the member store server 200d may be constructed such that it is possible to check detailed product information and payment-related information through the member store server 200d as needed. In this case, the mobile terminal 100d may request and receive detailed product information and payment-related information from the member store server 200d.

The member store server 200d includes not only a server that is directly operated by the member store but also a server that is operated by a third party and that provides product information to the member store.

Here, preferably, the barcode includes the member store server address (for example, callback URL information) that provides detailed product information or the like and is programmed to allow the mobile terminal 100d to automatically access the member store server when data is extracted from the barcode. Thus, the customer may receive detailed information regarding the product and the member store from the member store server 200d simply by scanning the barcode using the mobile terminal 100d. The member store server 200d receives the barcode data including the product information from the mobile terminal 100d and transmits detailed product information or the like corresponding to the received barcode data to the mobile terminal 100d.

In this manner, the mobile terminal 100d may receive updated product information from the member store server 200d. Accordingly, in this case, essential product information (for example, a product code) may be written to the barcode and detailed product information (including updated information) may be registered in the member store server 200d to allow the mobile terminal 100d to request such detailed product information from the member store server 200d.

When the customer has made a request to purchase a product displayed on the screen of the mobile terminal 100d held by the customer, the member store server 200d transmits a page for payment methods selection to the mobile terminal 100d.

Generally, payment methods such as cash payment (for example, bank transfer or mobile phone micropayment), wire transfer, and credit card are displayed on the window, which enables payment methods selection, of the mobile terminal 100d to allow the customer to select a desired payment methods.

When the customer has selected a specific payment methods through the mobile terminal 100d, the relay server 300d transmits a page, which enables input of payment methods information, to the mobile terminal 100d.

The payment methods information includes an account number, a PIN number, an account holder, a social security number, and the like in the case of wire transfer, includes a card number, an expiration date, a PIN number, and the like in the case of credit card payment, and includes a mobile phone number, a social security number, and the like in the case of mobile phone micropayment.

The customer transmits the payment information to the relay server 300d held by the customer through the mobile terminal 100d to request payment for the product.

Upon receiving the payment information from the mobile terminal 100d, the relay server 300d transmits the payment information to a payment server 400d specified by the customer to request payment verification and approval of the product.

The payment server 400d determines whether or not the member store has been registered in a server of the same company based on the received payment information and then transmits a payment confirmation code for the requested payment upon determining that payment is possible.

In the mobile payment method using a barcode according to each of the above embodiments of the present invention, the customer may temporarily store information regarding products to be purchased in an Internet shopping cart before deciding to purchase the products and thereafter may pay for all the desired products stored in the cart at once.

As is apparent from the above description, a mobile payment method using a barcode according to the present invention has a variety of advantages.

For example, since a customer can perform payment for a product using a mobile terminal held by the customer, it is possible to reduce the time required to purchase a product offline. In addition, since a store owner or clerk of a member store can also perform a payment for a product, which a customer desires to purchase, using a mobile terminal held by the store owner or clerk, they do not need to be provided with an expensive credit card terminal and receipt paper, thereby reducing costs.

In addition, the customer can immediately apply a great amount of product information and bill information acquired in the course of daily life to their individual economic activities such as purchasing and payment using their mobile terminal and, on the other hand, the seller can easily establish a business cycle of production, marketing, and sale.

Further, customers can conduct individual economic activities through any medium such as an offline store's products, email, SMS messages, various advertising or promotional materials and can also easily pay for anything (for example, utility bills, electronic payment system bills, or email bills) other than products.

Furthermore, since the customer can make payment through their personal mobile terminal, it is possible to prevent exposure of their payment information and also to prevent card cloning through hardware manipulation of a POS, a terminal, a reader, or the like.

The mobile payment method using a barcode according to the present invention may be implemented in the form of program instructions that may be executed through various computer means to be recorded on a computer readable medium. The computer readable medium may include program instructions, data files, data structures, and the like individually or in combination. The program instructions recorded on the medium may be specifically designed for the present invention or may be well known to one of ordinary skill in the art of software.

Examples of the computer readable recording medium include a magnetic medium such as a hard disk, a floppy disk, or a magnetic tape, an optical medium such as CD-ROM or DVD, a magneto-optical medium such as a floptical disk, and a hardware device such as ROM, RAM, or a flash memory that is specially designed to store and execute program instructions.

The medium may also be a transmission medium such as a metal wire, a waveguide, or light including carriers transmitting signals representing program instructions, data structures or the like.

Examples of the program instructions include not only machine code generated by a compiler or the like but also high-level language codes that may be executed by a computer using an interpreter or the like. The hardware device described above may be constructed so as to operate as one or more software modules for performing the operations of the embodiments of the present invention, and vice versa.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A mobile payment method using a barcode, the method comprising:
scanning a barcode using a mobile terminal of a member store to extract product information and/or payment-related information written to the barcode;
inputting information of a payment methods selected by a customer to the mobile terminal and combining the input information with the extracted product information and payment-related information to generate payment information;
transmitting the payment information to a payment server through or without passing through a relay server; and
receiving, by the mobile terminal, a payment confirmation code from the relay server or the payment server.

2. The mobile payment method according to claim 1, further comprising receiving, by the mobile terminal, product information registered in a member store server from the member store server after extracting the product information and/or payment-related information written to the barcode.

3. The mobile payment method according to claim 1, wherein the mobile terminal is a smart phone, a PDA, or a tablet PC having a scanner function.

4. The mobile payment method according to claim 1, wherein the barcode is a one-dimensional barcode, a two-dimensional barcode, or a three-dimensional barcode.

5. A mobile payment method using a barcode, the method comprising:
scanning a barcode using a mobile terminal of a customer to extract product information and/or payment-related information written to the barcode;
inputting information of a payment methods selected by a customer to the mobile terminal and combining the input information with the extracted product information and payment-related information to generate payment information;
transmitting the payment information to a payment server through or without passing through a relay server; and
receiving, by the mobile terminal, a payment confirmation code from the relay server or the payment server.

6. The mobile payment method according to claim 1, further comprising receiving, by the mobile terminal, product information registered in a member store server from the member store server after extracting the product information and/or payment-related information written to the barcode.

7. The mobile payment method according to claim 5, wherein the mobile terminal is a smart phone, a PDA, or a tablet PC having a scanner function.

8. The mobile payment method according to claim 5, wherein the barcode is a one-dimensional barcode, a two-dimensional barcode, or a three-dimensional barcode.

9. A mobile payment method using a barcode, the method comprising:
receiving, by a member store server, a product code and/or payment-related information extracted from a barcode scanned using a mobile terminal held by a customer;
transmitting detailed product information and payment-related information corresponding to the received barcode data from the member store server to the mobile terminal; and
receiving, by the member store server, a payment confirmation code, which a payment server generates in response to a payment request from the mobile terminal, from the payment server or from a relay server.

10. The mobile payment method according to claim 9, wherein the mobile terminal is a smart phone, a PDA, or a tablet PC having a scanner function.

11. The mobile payment method according to claim 9, wherein the barcode is a one-dimensional barcode, a two-dimensional barcode, or a three-dimensional barcode.

12. A mobile payment method using a barcode, the method comprising:
receiving, by a relay server, product information and payment-related information acquired by scanning a barcode of a specific product using a mobile terminal held by a customer, a store owner, or a clerk and payment information including payment methods information corresponding to a payment methods selected by the customer from the mobile terminal;
transmitting the payment information from the relay server to a payment server to request payment verification and approval; and
receiving, by the relay server, a payment confirmation code from the payment server and transmitting the payment confirmation code from the relay server to a member store server and the mobile terminal.

13. The mobile payment method according to claim 11, wherein the mobile terminal is a smart phone, a PDA, or a tablet PC having a scanner function.

14. The mobile payment method according to claim 11, wherein the barcode is a one-dimensional barcode, a two-dimensional barcode, or a three-dimensional barcode.
